(19) United States
(12) Patent Application Publication
(10) Pub. No.: US 2014/0011617 A1
(43) Pub. Date: Jan. 9, 2014

(54) ROTARY CONNECTION

(71) Applicants: Tobias Montag, Uchtelhausen (DE); Thomas Dittrich, Hammelburg (DE)

(72) Inventors: Tobias Montag, Uchtelhausen (DE); Thomas Dittrich, Hammelburg (DE)

(73) Assignee: ROTARY CONNECTION SCHAEFFLER TECHNOLOGIES AG & CO. KG

(21) Appl. No.: 14/006,820

(22) PCT Filed: May 23, 2012
(86) PCT No.: PCT/EP2012/059602

§ 371 Date: Sep. 23, 2013

(30) Foreign Application Priority Data
Jun. 27, 2011 (DE) 102011078080.7

(51) Int. Cl. F16H 7/00

(52) U.S. Cl. CPC F16H 7/00
USPC 474/148

(57) ABSTRACT

A rotary connection for cranes, wind power plants, solar panels and the like, having an outer ring (1) and having an inner ring (2) which are arranged so as to be rotatable relative to one another, and also having a rotary drive (5). An inexpensive rotary drive, which takes up little installation space, for the rotary connection is attained according to the invention in that the rotary drive (5) is arranged within the inner ring (2) and acts on the inner ring (2) via a wraparound element (7; 17, 18). Without departing from this design principle, it may also be provided that the rotary drive is arranged within the outer ring (1) and acts on the outer ring (1), which is to be rotated, via a wraparound element. The wraparound element may be a flexible tensile element (7), for example a cable, a flat belt or a chain, or else may be a thrust element (17) which is flexurally rigid in a transverse direction, for example a thrust belt, a thrust chain or a thrust link belt.

### FIELD OF THE INVENTION

The invention relates to a rotary connection for cranes, wind turbines, solar panels, and the like, with an outer ring and an inner ring that are arranged so that they can rotate relative to each other, and also with a rotary drive.

### BACKGROUND

In DE 103 47 328 A1, a rotary connection is described that consists of two running rings that are arranged concentrically one inside the other and between which rolling bodies roll on associated raceways, wherein the outer ring has, on its outer lateral surface, outer teeth in which at least one pinion engages for transmitting forces. In practice, under high demands on the running and setting accuracy, this rotary connection has proven effective for strong forces acting on the rotary connection and a long service life that is maintenance-free for as much as possible. This rotary connection, however, is complicated and therefore expensive in production. The high expense in the production of this rotary connection results especially through the production of the teeth of the surrounding ring gear produced from a copper-tin alloy and also for the production of the teeth on the drive pinion.

A more economical rotary connection is described in DE 201 15 350 U1. In this rotary connection, the force is transmitted to an outer ring by a cable element that is set in a cable groove with several windings arranged in a spiral on the outer diameter of the outer ring. Each end of the cable guided away from the outer ring can be wound or unwound on a cable spindle, wherein the two cable spindles are driven at a synchronized rotational speed. This rotary connection can be produced economically, causes low assembly and maintenance expense, and allows greater flexibility with respect to the arrangement of the torque-generating and torque-transmitting machine elements. Because the drive is arranged outside of the outer ring, the inner space of the inner ring remains free, but there are increased space requirements outside of the outer ring for the two cable spindles that can be driven at a synchronized rotational speed.

With this background, the invention is based on the objective of providing a rotary connection that can be produced economically and whose outer area is free from drive elements and makes it possible, if necessary, to leave a larger partial area of the inner space of the inner ring free.

### SUMMARY

The invention relates consequently to a rotary connection for cranes, wind turbines, solar panels, and the like, with an outer ring and an inner ring that are arranged so that they can rotate relative to each other, and also with a rotary drive. For meeting the objective it is provided that the rotary drive is arranged within the inner ring and acts on the inner ring to be rotated by means of a wraparound element.

Without departing from this design principle, it can also be provided that the rotary drive is arranged within the outer ring and acts on the outer ring to be rotated by means of a wraparound element. The inner ring would then be arranged locked in rotation in the radial direction within the rotatable outer ring and the rotary drive, wherein the outer ring is supported so that it can rotate on the inner ring with axial distance to the rotary drive.

The wraparound element can be an elastic pulling element, for example, a cable, a flat band, or a chain, or it can be a thrust element, for example, a thrust band, a thrust chain, or a thrust link band, that is flexurally rigid in the transverse direction.

If the pulling element is a cable, this can be mounted on a mounting point of the inner surface of the inner ring, and guided by means of a plurality of guide rollers distributed uniformly across the inner surface of the inner ring and tangent to this surface, and also by means of a drive drum spaced in the radial direction to the inner surface.

In contrast, if the wraparound element is a thrust element, it can be formed of at least one steel band that is bulged in the transverse direction and mounted at a mounting point on the inner surface of the inner ring, it is guided flat on the inner surface by a plurality of guide rollers distributed uniformly across the inner surface and tangent to this surface, and can be wound and unwound on a drive roller spaced in the radial direction relative to the inner surface. The guide rollers can be spring-mounted or arranged with a small distance to the inner surface of the inner ring.

Therefore, because both the pulling element and also the thrust element are guided by the guide rollers close or directly on the inner surface of the inner ring and the drive drum has, in comparison to the inner diameter of the inner ring, a small diameter, a large area of the inner space of the inner ring remains free for guiding, for example, electrical, pneumatic, and/or hydraulic lines.

This free space can be increased if the drive roller is arranged offset to the axle in the direction of the inner surface of the inner ring.

The drive with the wraparound element can be assembled and disassembled in a simple way within the inner ring, requires no high-precision processing of the inner surface of the inner ring, and needs only one simple gear motor for driving the drive drum.

For applying a pretensioning force on the pulling element formed as a cable, the drive drum can be displaced in the radial direction and can be fixed.

A mounting of the pulling element formed as a cable on the drive drum is not needed, if the cable is wrapped completely around the drive drum at least once. Through the pretensioning force on the cable and the increased friction caused by the wrapping around the drive drum, a secure drive is guaranteed.

If the applied pretensioning force is not too high, then the cable can also be wrapped several times around the drive drum, wherein the self-locking effect of the cable on the drive drum is significantly increased.

The pulling element can also be formed of an elastic textile, plastic, or steel band or can also be formed as a chain. For the wraparound elements formed as elastic pulling elements, the areas of the pulling element between the guide rollers run as cords and accordingly contact the inner surface of the inner ring only in the area of the guide rollers.

If the wraparound element is a thrust element that is flexurally rigid in the transverse direction, for example, a thrust band, a thrust chain, or a thrust link band, the thrust element contacts the inner surface of the inner ring when a thrust force is applied. Only the thrust element areas guided by adjacent guide rollers to the drive roller are free and must be guided on the side allowing bending by guide rails extending from the guide rollers to the drive roller. Guide rails are typical structural elements in drives with wraparound elements that are formed as thrust elements.

Steel bands that are bulged in the transverse direction and are similar to those used in rolling steel band tape measures are flexurally rigid in the direction to the convex surface as long as they remain bulged. They are elastic in the direction to the concave surface and are spread flat under a bending force. Accordingly, with its flat, spread-out surface that is convex in the straight state, such a steel band contacts the inner surface of the inner ring and is held in contact by the guide rollers. The steel band areas of adjacent guide rollers to the drive roller are free and bulge out, so that they are elastic in this area to the concave side and flexurally rigid to the convex side. To prevent kinking of these band areas when a compressive force is applied by the drive drum, the already mentioned guide rails are arranged on the convex side of the steel band.

Advantageously, two steel bands bulged in the transverse direction are arranged next to each other in the axial direction and are mounted next to each other on the inner surface of the inner ring and on the outer surface of the drive roller and can also be alternatively wound and unwound on the drive roller.

For guiding the steel bands, the guide rollers and the drive drum are advantageously provided with guide skirts.

The drive of the drive drum can be electrical, hydraulic, pneumatic, or manual.

### BRIEF DESCRIPTION OF THE DRAWING

The invention is described in more detail below using two embodiments shown in the accompanying drawing. Shown in the drawing are:

FIG. 1 is a top view of a rotary connection according to the invention with a wraparound element formed as a pulling element,

FIG. 2 is a cross-sectional view along the section line II-II in FIG. 1,

FIG. 3 is a top view of a rotary connection according to the invention with a wraparound element formed as a thrust element, and

FIG. 4 is a sectional view according to the section line IV-IV in FIG. 3.

### DETAILED DESCRIPTION OF THE PREFERRED EMBODIMENTS

The rotary connection according to the invention is formed of an outer ring 1 that is fixed in rotation and an inner ring 2 that can rotate, wherein the outer ring 1 has connection holes 3 and the inner ring 2 has connection holes 4, in order to mount the rotary connection on fixed or rotatable adjacent components.

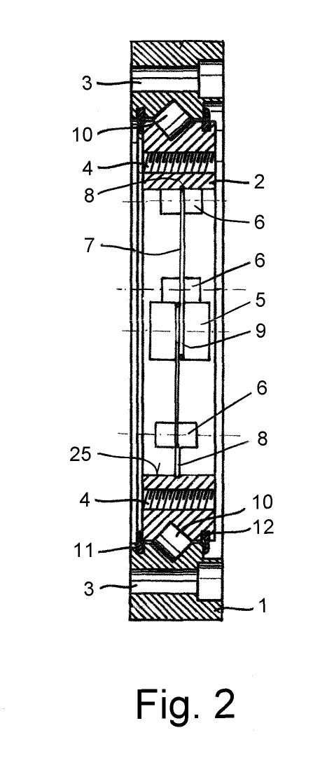

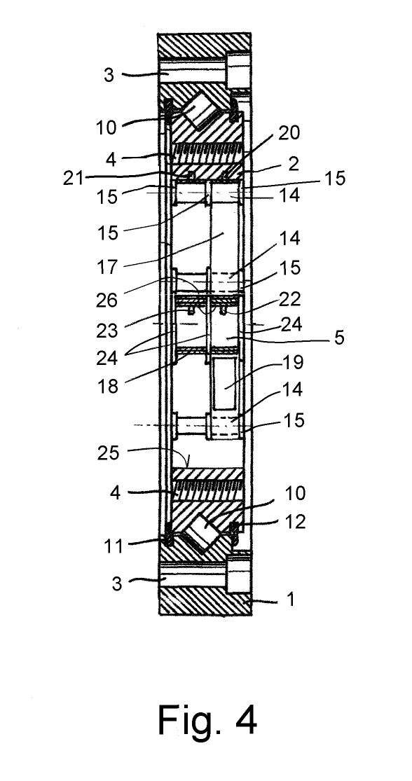

From FIGS. 2 and 4 it can be seen that the rotary connection is a cross roller bearing with cross rollers 10. Between the outer ring 1 and the inner ring 2 there are seals 11, 12 on both sides of the cross rollers 10. Any other useful bearing could also be used.

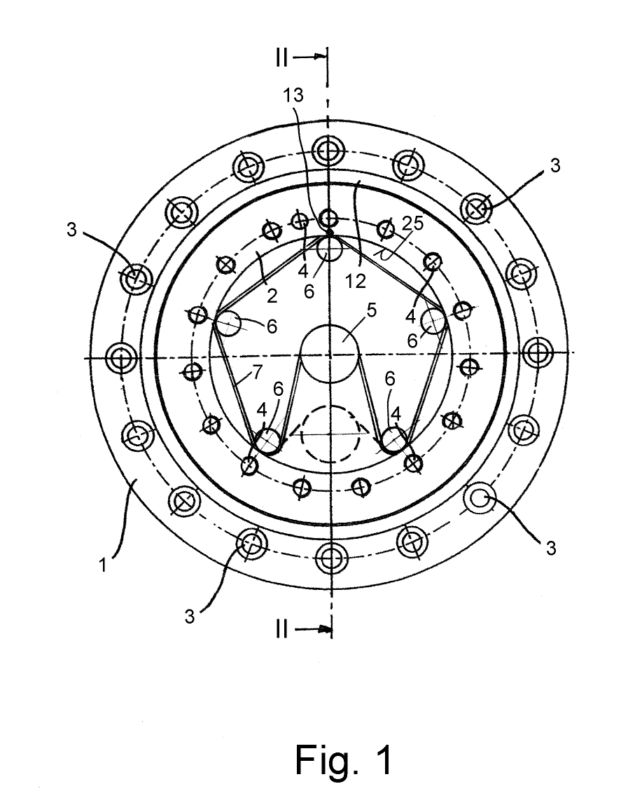

The embodiment according to FIGS. 1 and 2 comprises a wraparound element in the form of an elastic cable 7. The cable 7 is mounted at a mounting point 13 on an inner surface 25 of the inner ring 2. Guide rollers 6 arranged tangential to the inner surface 25 of the inner ring 2 are spaced apart uniformly relative to each other. The cable 7 is guided by these guide rollers up to a drive drum 5. The inner surface 25 of the inner ring 2 is here provided with a guide groove 8 in which the cable 7 is guided in the area of the guide rollers 6. The guide groove 8 is not absolutely necessary, but is merely advantageous for solving the stated problem.

The inner ring 2 is located in the position shown in FIG. 1 in a middle position relative to the outer ring 1, which means that the mounting point 13 for the cable 7 is located symmetric to the other four guide rollers 6 relative to a guide roller 6. The cable 7 is guided from the adjacent guide rollers 6 opposite the mounting point 13 to the drive drum 5 that is provided with a guide groove 9 for the cable. The guide groove 9 has, in the shown embodiment, twice the width of the cable diameter, so that the cable 7 can be wound once completely around the drive drum 5.

The drive drum 5 is shown in a position providing the cable 7 with a pretensioning force and is located essentially coaxial to the inner ring 2. By applying the pretensioning force by shifting the drive drum 5 away from a position shown with dashed lines, the cable 7 is tensioned so that the areas between the guide rollers 6 run as cords.

By means of a suitable, not-shown drive, the drive drum 5 can rotate in one or the other rotational direction and therefore causes a rotation of the inner ring 2 relative to the outer ring 1. The rotational angle of the inner ring 2 is here limited after both sides until reaching each drive roller 6 through the mounting point 13 on the inner ring by which the cable 7 is guided to the drive drum 5. In the shown embodiment with five guide rollers 6 spaced apart uniformly, the rotational angle is 144° in each direction, i.e., total 288°, so that the rotary connection according to the invention can be used in applications that do not require a complete rotation by 360° or more. This is applicable to a lesser extent for cranes, but is given without additional elements for adjusting the angle of incidence for the rotor blades of wind turbines or for solar panels. If wrapped around two or more times, an angle greater than 360° can also be realized, for example, 648°.

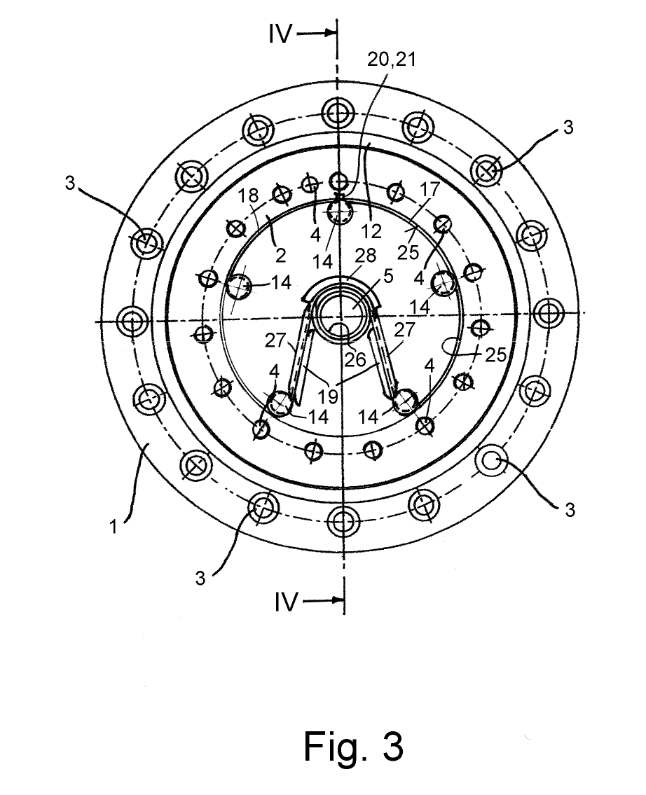

The embodiment according to FIGS. 3 and 4 shows a wraparound element formed as a thrust element 17, 18 in a device formed according to the invention.

Like in the embodiment according to FIGS. 1 and 2, the rotary connection shown in FIGS. 3 and 4 is formed of an outer ring 1 that is fixed in rotation and an inner ring 2 that can rotate in which connection holes 3, 4 are arranged for guiding fastening elements, such as screws. In this case, as an example, cross rollers 10 are arranged between the outer ring 1 and the inner ring 2 and seals 11, 12 are arranged on both sides of these rollers. The thrust element is formed of two bulged steel bands 17, 18 in extended form, similar to that used in windable tape measures. In the bent state, the steel bands 17, 18 are flat and bulged only in the extended state and also, in this state, flexurally rigid in the direction of the convex side of the steel bands 17, 18 and elastic in the direction of the concave side.

Two bulged steel bands 17, 18 are arranged next to each other and adjacent and mounted with its ends at mounting points 20, 21 on the inner ring 2 and at mounting points 22, 23 on the outer surface 26 of the drive drum 5. The steel bands 17, 18 contact the inner surface 25 of the inner ring 2 flat in the bent state and are there guided by guide rollers 14 with guide skirts 15. Of the adjacent guide rollers 14 that are essentially opposite the guide roller 14 where the mounting points 20, 21 of the steel bands 17, 18 on the inner surface 25 of the inner ring 2, steel band areas 27 are guided in a straight line to the drive drum 5. After being deflected by the guide rollers 14, these steel band areas 27 bulge out and are flexurally rigid in the direction of the convex side. In order to avoid kinking of the steel band areas 27 when a thrust force is applied by means of the drive drum 5, straight guide rails 19 are arranged on the convex side of the steel band areas 27.

On the drive drum 5, as many windings of the steel bands 17, 18 are wound as corresponds to the distance from the two lower guide rollers 14 up to the upper guide roller 14 in FIG. 3.

If the drive drum 5 is set in rotation by a not-shown electrical, hydraulic, pneumatic, or mechanical drive, the one steel band 17 winds on the drive drum 5 and the other steel band 18 unwinds from the drive drum 5, and a thrust force is generated by means of the bulged steel band area 27 and sets the inner ring 2 in a right-hand rotation. If the drive drum 5 is driven in the opposite rotational direction, the rotation of the inner ring 2 also takes place in the opposite direction.

In order to prevent a lifting of the steel band windings from the drive drum 5, a corresponding circular segment-shaped guide rail 28 is provided that is adapted in a known way to the diameter of the windings on the drive drum 5. This takes place through an articulated formation of the guide rail 28 whose one end is fixed and whose other end is pulled in a suitable way against the windings on the drive roller 5. In addition the drive drum 5 has radial directed guide skirt 24 to the side and between the steel bands 17, 18.

Instead of the bulged steel bands 17, 18, thrust chains or thrust link bands can also be used, in particular, high thrust forces can occur.

The rotatable bearing of the inner ring 2 relative to the outer ring 1 is not limited to a cross roller bearing. Likewise a sliding bearing is also possible, as is shown, for example, in DE 201 15 350 U1.

In the embodiments according to FIGS. 3 and 4, the drive drum 5 does not have to be arranged coaxial to the outer ring 1 and inner ring 2, but instead can also be arranged offset to the axis in the direction of the lower guide rollers 14, in order to create more free space within the inner ring 2.

### LIST OF REFERENCE SYMBOLS

1 Outer ring
2 Inner ring
3 Connection hole
4 Connection hole
5 Drive drum
6 Guide rollers
7 Cable
8 Guide groove
9 Guide groove
10 Cross roller
11 Seal
12 Seal
13 Mounting point on the inner ring
14 Guide roller
15 Guide skirt
17 Steel band
18 Steel band
19 Guide rail
20 Mounting point on the inner ring
21 Mounting point on the inner ring
22 Mounting point on the drive drum
23 Mounting point on the drive drum
24 Guide skirt on the drive drum
25 Inner surface of the inner ring
26 Outer surface of the drive drum
27 Bulged steel band areas
28 Guide rail

1. A rotary connection, comprising an outer ring and an inner ring that are arranged to rotate relative to each other, and a rotary drive, arranged within the inner ring that acts on the inner ring via a wraparound element.

2. A rotary connection, comprising an outer ring and an inner ring that are arranged to rotate relative to each other, and with a rotary drive, arranged within the outer ring that acts on the outer ring via a wraparound element.

3. The rotary connection according to claim 1, wherein the wraparound element is an elastic pulling element.

4. The rotary connection according to claim 1, wherein the wraparound element is a thrust element, a thrust band, a thrust chain, or a thrust slide band, that is flexurally rigid in a transverse direction.

5. The rotary connection according to claim 3, wherein the pulling element is a cable that is mounted on a mounting point on an inner surface of the inner ring and is guided by a plurality of guide rollers distributed uniformly across the inner surface and tangential to the inner surface and is guided by a drive drum of the rotating drive spaced radial to the inner surface.

6. The rotary connection according to claim 5, wherein the cable is wrapped completely around the drive drum at least once.

7. The rotary connection according to claim 4, wherein the thrust element is formed of at least one steel band that is bulged in the transverse direction and is mounted at a mounting point on an inner surface of the inner ring and is guided flat on the inner surface by a plurality of guide rollers distributed uniformly across the inner surface and tangential to the inner surface and is windable and unwindable on a drive drum of the rotating drive spaced in a radial direction to the inner surface.

8. The rotary connection according to claim 7, wherein the bulged steel band areas guided by the plurality of adjacent guide rollers that are adjacent to the drive roller are guided on the convex steel band side by guide rails extending from the guide rollers to the drive roller.

9. The rotary connection according to claim 7, wherein two of the steel bands bulged in the transverse direction are arranged next to each other in the axial direction, are mounted next to each other on the inner surface of the inner ring and an outer surface of the drive drum, and are alternatively windable and unwindable on the drive drum.

10. The rotary connection according to claim 7, wherein the guide rollers and the drive drum are provided with guide skirts.

11. The rotary connection according to claim 5, wherein the drive drum is shiftable in a radial direction and is fixable for applying a pretensioning force on the pulling element or the thrust element.
